(19) United States
(12) Patent Application Publication
(10) Pub. No.: US 2022/0161534 A1
(43) Pub. Date: May 26, 2022

(54) BIAXIALLY ORIENTED POLYESTER REFLECTIVE FILM AND MANUFACTURING METHOD THEREFOR

(71) Applicant: TORAY ADVANCED MATERIALS KOREA INC., Gyeongsangbuk-do (KR)

(72) Inventors: Jee Hyuk KIM, Gyeongsangbuk-do (KR); Kil Joong KIM, Gyeongsangbuk-do (KR); Seo Jin PARK, Gyeongsangbuk-do (KR)

(21) Appl. No.: 17/442,248

(22) PCT Filed: Dec. 18, 2019
(86) PCT No.: PCT/KR2019/018037

§ 371 Date: Sep. 23, 2021

(30) Foreign Application Priority Data
Mar. 28, 2019 (KR) 10-2019-0036388

(51) Int. Cl. B32B 27/36; B32B 27/20; B32B 27/32; B32B 27/08; B32B 3/30; B32B 3/26

(52) U.S. Cl. CPC B32B 27/36; B29K 2067/003; B32B 27/32; B32B 27/08; B32B 3/30; B32B 3/266; B32B 2307/732; B32B 2307/416; B32B 2270/00; B32B 2264/1021; B32B 2264/104; B32B 2307/518; B32B 2250/40; B32B 2250/24; B32B 2307/51; B32B 2457/20; B32B 2250/03; B32B 27/20

(57) ABSTRACT

The present invention relates to a biaxially oriented polyester reflective film capable of retaining excellent reflection characteristics even after vacuum compression molding and hot press molding by suppressing deformation of an internal porous layer of the reflective film during molding, and a process of producing the same.

### TECHNICAL FIELD

The following description relates to a biaxially oriented polyester reflective film and a process for producing the same, and more specifically, to a biaxially oriented polyester reflective film which has excellent moldability and is capable of retaining excellent reflection characteristics even after vacuum compression molding and hot press molding by suppressing deformation of an internal porous layer of the reflective film during molding, and a method of producing the same.

### BACKGROUND

Liquid crystal displays which has been widely applied to all range of applications, such as mobile devices, tablet devices, monitors, notebook computers, and TVs, are not self-luminous devices, and thus require a backlight unit that provides light from a back side. In the past, a line light source using a cold cathode ray tube was usually used as a light source of a backlight unit, but recently a point light source using a light emitting diode (LED) is being widely used.

The point/line light source of a backlight unit is required to be converted into a surface light source to be utilized as a display. To this end, the point light source is converted into a surface light source through, in addition to the light source, various optical sheet configurations, such as a light guide plate that transfers LED light emitted from a side to a front surface, a reflective film that reflects the light lost to the rear side of the display back to the front surface, a diffusion film that uniformly diffuses the light irradiated to the front surface, a prism film that concentrates diffused light into front light. A liquid crystal display using a surface light source converted through a backlight unit includes a polarizing film, a thin film transistor (TFT), liquid crystal, a color filter, a polarizing filter, and the like in a panel portion to implement R/G/B colors in each pixel unit. In the case of the liquid crystal display, a contrast ratio representing the brightness and darkness of the light is realized by applying a voltage to the panel portion to block or transmit the light through the arrangement of liquid crystals, but there is a problem in that the contrast ratio of color is significantly lower than that of an organic light emitting diode (OLED), which is a self-luminous element in which each pixel emits light by itself.

For this reason, the display industry is actively developing a method of improving the contrast ratio of a liquid crystal display using a local dimming method in which a point light source is individually turned on/off using a plurality of LEDs. In the case where the plurality of LEDs are individually driven, as one of methods for solving interference of light between the LED elements, a method of forming recesses and holes repeatedly on a reflective film and mounting the LEDs thereinto is being researched.

However, when a reflective film is molded with high temperature, a conventional reflective film may not be sufficiently molded into a desired shape, or pores inside the reflective film are deformed during molding, and thereby reflection characteristics are rapidly degraded. Accordingly, there is a need for a reflective film that has excellent moldability and retains reflection characteristics after molding.

As a related art, Japanese Laid-Open Patent Publication No. 2007-261260 discloses a reflective film comprising polyester resin as a main component, wherein an attempt is made to enhance the reflection performance of the film by improving a manufacturing process with the optimal combination of weight ratios of inorganic particles and resins incompatible with polyester. However, since the aforementioned related art only improves the general reflection performance, problems of insufficiency of moldability and pore deformation during molding cannot be overcome.

### SUMMARY

### Technical Problem

The present invention has been conceived to solve the aforementioned problems and to meet the conventional requirements. An objective of the present invention is to provide a biaxially oriented polyester reflection film capable of improving moldability and retaining excellent reflection characteristics after molding, and a method of producing the same.

The above and other purposes and advantages of the present invention will be more apparent from the following disclosure of preferred exemplary embodiments.

### Technical Solution

In one general aspect, there is provided a biaxially oriented polyester reflective film including a light reflection layer having pores inside thereof and a support layer formed on at least one surface of the light reflection layer, wherein the light reflection layer comprises a polyester composition including homopolyester, copolymer polyester, resin incompatible with polyester, and inorganic particles, the support layer comprises a polyester composition including homopolyester, copolymer polyester, and inorganic particles, and a plurality of light collecting structures recessed at center thereof are arranged in a lattice shape and a hole is formed in a recess portion.

The polyester composition of the light reflection layer may satisfy the following conditions (1) to (3):
(1) 8% by volume≤Vo+Vi≤20% by volume
(2) 0.5≤Vo/Vi≤1.6
(3) 0.6≤(Vo+Vi)/Vc≤3

, wherein Vo denotes volume % of the resin incompatible with polyester, Vi denotes volume % of the inorganic particles, and Vc denotes the volume % of copolymer polyester when the weight of each component based on total 100% by weight of the polyester composition is divided by specific gravity.

Storage elastic modulus E′ of the biaxially oriented polyester reflective film at 200° C. may be 40 MPa to 100 MPa.

The copolymer polyester may be a polymer obtained by a polycondensation reaction of 100 mol % of aromatic dicarboxylic acid as an acid component, 60 to 90 mol % of ethylene glycol as total diol components, and 10 to 40 mol % of one or more diol components selected from a group consisting of trimethylene glycol, tetramethylene glycol, 2,2 dimethyl (1, 3-propane) diol, and 1,4-cyclohexanedimethanol.

The resin incompatible with polyester may be at least one selected from crystalline polyolefin resins, non-crystalline cyclic olefin resins, thermosetting polystyrene resins, thermosetting polyacrylate resins, polypetylenesulfide resins, and fluorine-based resins, or a homopolymer or copolymer thereof.

Glass transition temperature of the resin incompatible with polyester may be 160° C. or higher.

The inorganic particles may include at least one inorganic particle selected from the group consisting of silica, alumina, barium sulfate, titanium dioxide, and calcium carbonate.

An average particle diameter of the inorganic particles of the light reflection layer may be more than 0.2 μm and less than 1.2 μm.

An average particle diameter of the inorganic particles of the support layer may be more than 0.1 μm and less than 10.0 μm.

A total thickness of the biaxially oriented polyester reflective film is 150 μm to 400 μm.

A thickness of the support layer may be more than 1.0% and less than 10.0% of a thickness of the light reflection layer.

Specific gravity of the biaxially oriented polyester reflective film may be 0.7 to 1.2 g/cm³.

A physical properties change of a center portion of the recess portion recessed at the center thereof in the biaxially oriented polyester reflective film before and after molding using a molding mold may satisfy conditions (4) to (7) below:
(4) Optical density (OD) before molding >1.4
(5) Decrease in OD before and after molding <0.15
(6) Deviation of OD after molding <7%
(7) Decrease in thickness (d) before and after molding <30%.

The biaxially oriented polyester reflective film after molding using a molding mold satisfies Equation 1 below:

$$\frac{{WA}_{r} - {WA}_{m}}{{WA}_{r}} \times \leq 100 \% \leq 5 \% , \qquad ( Equation 1 )$$

wherein WAₘ denotes a wall angle of the molding mold and WAᵣ denotes a wall angle of the reflective film after molding.

In another general aspect, there is provided a method of producing a biaxially oriented polyester reflective film including a first step of drying each of a polyester composition of a support layer A and a polyester composition of a light reflection layer B; a second step of preparing an non-stretched sheet by melt-extruding the compositions of the first step; a third step of preparing a uniaxially stretched reflective film by uniaxially stretching the non-stretched sheet in a longitudinal direction; a fourth step of preparing a biaxially stretched reflective film by stretching again the uniaxially stretched reflective film in a transverse direction; a fifth step of performing heat treatment on the biaxially stretched reflective film; a sixth step of cooling and winding the heat-treated reflective film; a seventh step of molding the reflective film produced in the sixth step into a form in which a plurality of recessed light collecting structures are arranged in a lattice shape using a molding mold; and an eighth step of forming (punching) holes for mounting LEDs in the recessed light collecting structures of the reflective film produced in the seventh step.

### Advantageous Effects

According to the present invention, excellent moldability, light reflection characteristics, stability of film forming, and low molding deviation are realized before and after molding.

In addition, the present invention is usefully applicable to a reflective film for local dimming liquid crystal display.

However, the effects of the present invention are not limited to the aforementioned effects, and other effects, which are not mentioned above, will be apparent to those skilled in the art from the foregoing description.

### BRIEF DESCRIPTION OF THE DRAWINGS

FIG. 1 is a cross-sectional view of a biaxially oriented polyester reflective film according to one embodiment of the present invention.

FIG. 2 is an enlarged cross-sectional view of the biaxially oriented polyester reflective film according to one embodiment of the present invention.

FIG. 3 is a plan view of the biaxially oriented polyester reflective film according to one embodiment of the present invention.

FIG. 4 is a diagram for describing a molding process of the biaxially oriented polyester reflective film according one embodiment of the present invention.

### DETAILED DESCRIPTION

Hereinafter, embodiments of the present invention will be described in detail with reference to the accompanying drawings so as to be easily practiced by a person of ordinary skill in the art. It should be understood that the present invention is not to be construed as limited to the embodiments set forth herein and may be embodied in many different forms.

Unless otherwise defined, all technical and scientific terms used herein have the same meaning as commonly understood by one of ordinary skill in the art to which this invention belongs. In case of conflict, the specification, including definitions, will control.

In addition, although methods and materials similar or equivalent to those described herein can be used in the practice or testing of the invention, suitable methods and materials are described herein.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or.

In describing and/or claiming this invention, the term “copolymer” is used to refer to polymers formed by copolymerization of two or more monomers. Such copolymers include dipolymers, terpolymers or higher order copolymers.

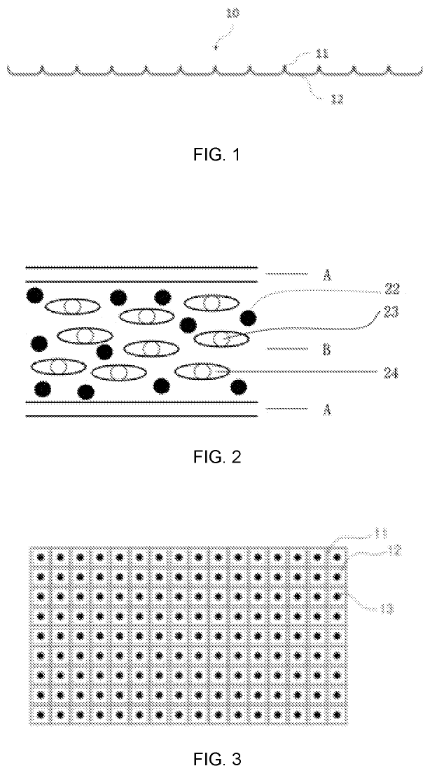

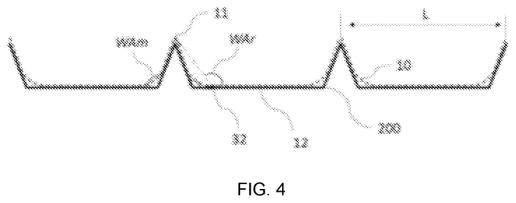

FIG. 1 is a cross-sectional view of a biaxially oriented polyester reflective film according to one embodiment of the present invention, FIG. 2 is an enlarged cross-sectional view of the biaxially oriented polyester reflective film according to one embodiment of the present invention, FIG. 3 is a plan view of the biaxially oriented polyester reflective film according to one embodiment of the present invention, and FIG. 4 is a diagram for describing a molding process of the biaxially oriented polyester reflective film according one embodiment of the present invention.

Referring to FIGS. 1 to 3, the biaxially oriented polyester reflective film 10 according to one aspect of the present invention has a multi-layer structure including a light reflection layer B having pores 24 therein and a support layer A formed on at least one surface of the light reflection layer B, and has a structure and raw material composition which will be described below.

As shown in FIGS. 1 to 3, the biaxially oriented polyester reflective film 10 according to one embodiment of the present invention has a structure in which a plurality of [symbol] -shaped light collecting structures having a recess portion 12 at the center thereof are arranged in a lattice shape, and a hole 13 is formed on the recess portion 12.

Convex portions 11 and the recess portion 12 are repeatedly formed on the reflective film according to the lattice shape of the recessed light collecting structure. By reflecting light through the recessed light collecting structure so that the light is not scattered in all directions but is concentrated in the center, it is possible to minimize the effect of reflected light of a bright region on a dark region during local dimming, thereby enabling local dimming for individual light emitting diodes (LEDs).

In FIG. 3 the square-shaped recessed light collecting structures are arranged in a lattice shape, but this is merely an example, and the lattice shape is not limited to the square shape, such that various lattice shapes, such as circular, elliptical, and regular hexahedral shapes, may be possible.

The biaxially oriented polyester reflective film 10 according to one embodiment of the present invention may be produced in an NB two-layer structure of support layer A/light reflection layer B in which the support layer A is formed only on one surface of the light reflection layer B. In addition, the biaxially oriented polyester reflective film 10 according to one embodiment of the present invention may be produced in an A/B/A three-layer structure of support layer A/light reflection layer (B)/support layer, in which the support layer A is formed on both surfaces of the light reflection layer B. For example, the A/B/A three-layer structure is preferable in view of stability of film forming, defect control, and processing stability. In the case of A/B two-layer structure, the support layer A serving as a support layer is formed only on one surface of the film when the film is formed, and hence processing defects, such as film tearing, may occur due to lack of support layer in the film processing process, which may cause a decrease in productivity. Also, the light reflection layer B having the pores 24 formed therein forms a surface layer on the other surface, so that the pores 24 are likely to cause a crater-like appearance on the surface layer, and defects such as cracks or dents may be caused on the surface of the reflective film by the pores 24 in the course of secondary processing, such as bead-coating, or when the reflective film is inserted in a backlight unit, cracks or dents on the reflective film surface at the contact surface with a light guide plate are highly likely to occur. Thus, it is more preferable that the multi-layer structure of the biaxially oriented polyester reflective film 10 according to one embodiment of the present invention has an A/B/A three-layer structure of a support layer A/light reflection layer B/support layer A. For example, FIG. 2 shows a biaxially oriented polyester reflective film 10 formed with a A/B/A three-layer structure of support layer(A)/light reflection layer(B)/support layer(A).

In one embodiment, the light reflection layer B may comprise a polyester composition which comprises homopolyester as a main component and includes a copolymer polyester, resins 23 having incompatibility with polyesters, and inorganic particles 22.

Also, the support layer A may comprise a polyester composition which comprises a homopolyester as a main component and includes copolymer polyesters and inorganic particles.

The homopolyester is a polymer obtained by a polycondensation reaction from a dicarboxylic acid and a diol component. It is preferable to solely use, as a dicarboxylic acid component, one selected from dimethyl terephthalate, terephthalic acid, isophthalic acid, 2,6-naphthalenedicarboxylic acid, sebacic acid, adipic acid, diphenyldicarboxylic acid, 5-tert-butylisophthalic acid, 2,2,6,6-tetramethyldiphenyl-4,4-dicarboxylic acid, 1,3-trimethyl-3-phenylphosphate-4,5-dicarboxylic acid, 5-sodiumsulfoisophthalic acid, trimellitic acid, oxalic acid, malonic acid, succinic acid, glutaric acid, palmic acid, azelaic acid, pyromellitic acid, 1,4-cyclohexanedicarboxylic acid, 1,3-cyclohexanedicarboxylic acid, and the like, and it is more preferable to use dimethyl terephthalate, terephthalic acid, and the one selected. It is preferable to solely use, as the diol component, one selected from ethylene glycol, trimethylene glycol, tetramethylene glycol, 2,2 dimethyl (1, 3-propane) diol, 1,4-cyclohexanedimethanol, and the like, and it is more preferable to use ethylene glycol.

In addition, the copolymer polyester is a polymer obtained by a polycondensation reaction of two or more of dicarboxylic acids or diol components among the homopolyester components. It is preferable to use in combination with isophthalic acid, 2,6-naphthalenedicarboxylic acid, and the like in addition to terephthalic acid, as a dicarboxylic acid component, and as the diol component, it is preferable to use a copolymer polyester formed in combination with trimethylene glycol, tetramethylene glycol, 2,2 dimethyl (1, 3-propane) diol, 1,4-cyclohexanedimethanol, and the like, in addition to ethylene glycol.

In one embodiment, the copolymer polyester according to the present invention is preferably a polymer obtained by a polycondensation reaction of 100 mol % of aromatic dicarboxylic acid as an acid component, 60 to 90 mol % of ethylene glycol as total diol components, and 10 to 40 mol % of one or more diol components selected from a group consisting of trimethylene glycol, tetramethylene glycol, 2,2 dimethyl (1, 3-propane) diol, and 1,4-cyclohexanedimethanol.

The resin 23 incompatible with polyester is preferably at least one selected from crystalline polyolefin resins, non-crystalline cyclic olefin resins, thermosetting polystyrene resins, thermosetting polyacrylate resins, polypetylenesulfide resins, and fluorine-based resins, or a homopolymer or copolymer thereof, and more preferably a non-crystalline cyclic polyolefin resin.

In addition, glass transition temperature Tg of the resin incompatible with polyester is preferably 160° C. or higher. When the glass transition temperature Tg of the resin incompatible with polyester is less than 160° C., resin particles incompatible with polyester formed in the pores in the light reflection layer are easy to deform during the high-temperature molding processing process, which may cause a problem of deteriorating the light reflection performance.

The inorganic particles 22 preferably include at least one inorganic particle selected from the group consisting of silica, alumina, barium sulfate, titanium dioxide, and calcium carbonate, and more preferably a calcium carbonate particle.

In addition, the average particle diameter of the inorganic particles 22 used in the light reflection layer B, among inorganic particles, is preferably more than 0.2 μm and less than 1.2 μm. This is because, if the diameter of the inorganic particle used for the light reflection layer B is 1.2 μm or more, the density of a pore layer formed by the inorganic particles is noticeably decreased, so that the reflection characteristics are remarkably degraded. If the diameter is 0.2 μm or less, dispersion in the light reflection layer is difficult and aggregation of the particles is easily caused. Moreover, when a prepared polyester reflective film is subjected to press molding or vacuum compression molding at high temperature, deformation of the pores 24 in the polyester reflective film is caused by high-temperature heat and pressure. In this case, when the size of the inorganic particles is 0.2 μm or less, the particles cannot serve as a support that minimizes the change of the pores 24 in the film, so that a problem occurs in that the specific gravity of the reflective film rises and the reflection characteristics are significantly degraded after molding.

In addition, the average particle diameter of the inorganic particles used for the support layer A among the inorganic particles is preferably more than 0.1 μm and less than 10.0 μm, and more preferably more than 1.0 μm and less than 5.0 μm. This is because, if the size of the inorganic particles used for the support layer A is 0.1 μm or less, the running properties of the film is significantly insufficient in the film-forming process, so that a large amount of scratches are generated on the film surface. If the size of the particles is 10.0 μm or more, processing defects, such as tearing of the film during stretching process, may be caused by large-sized particles in the film-forming process.

In one embodiment, the polyester composition of the light reflection layer B comprises homopolyester as a main component, and includes a copolymer polyester, a resin incompatible with polyester, and inorganic particles, wherein when the weight of each component of the copolymer polyester, the resin incompatible with polyester, and the inorganic particles, based on 100% by weight of the polyester composition forming the light reflection layer, is divided by specific gravity, the following conditions (1) to (3) are preferably satisfied in order to achieve moldability at high temperature and excellent reflection characteristics after molding.
(1) 8% by volume≤Vo+Vi≤20% by volume
(2) 0.5≤Vo/Vi≤1.6
(3) 0.6≤(Vo+Vi)/Vc≤3

Here, Vo denotes volume % of the resin incompatible with polyester, Vi denotes volume % of the inorganic particles, and Vc denotes volume % of copolymer polyester.

Based on numerous experiments, the inventors of the present invention have confirmed that excellent reflection characteristics before and after press molding and vacuum compression molding and excellent molding processability are achieved at high temperature when the contents of the homopolyester resin, the copolymer polyester resin, the resin incompatible with polyester, and the inorganic particles in the polyester composition of the light reflecting layer B constituting the biaxially oriented polyester reflective film satisfy the above conditions.

That is, as can be confirmed in the Examples and Comparative Examples below, when a value of condition (1) is less than 8% by volume, a void density in the light reflection layer is lowered and thus it is difficult to achieve sufficient light reflection efficiency, and when the value exceeds 20% by volume, many pores (voids) are formed in the film and thus stretchability is significantly reduced, which is likely to cause the processing defects, such as film tearing, during the film forming.

In addition, when a value of condition (2) is less than 0.5, the storage elastic modulus of the reflective film at 200° C. is increased, so that the film may be torn or be difficult to be sufficiently molded during molding processing, and when the value exceeds 1.6, the storage elastic modulus of the reflective film at 200° C. is lowered, so that the moldability is increased during molding processing whereas a sharp decrease in the film thickness and optical density may be caused due to deformation. Deterioration of optical characteristics after molding is caused by that the pores 24 in the polyester reflective film are deformed due to high-temperature heat and pressure when press molding or vacuum compression molding is performed at high temperature. In this case, the inorganic particles serve as a support that minimizes the change of pores in the film.

Also, when a value of condition (3) is less than 0.6, the relative content of the copolymer polyester resin is increased, and thus the stretchability is enhanced during film forming process whereas the storage elastic modulus E′ of the reflective film at 200° C. is decreased, which may cause a drastic decrease in the film thickness and optical density due to deformation during molding processing. When the value of condition (3) exceeds 3, the relative content of the copolymer polyester resin is decreased, accordingly, the storage elastic modulus E′ of the reflective film at 200° C. is increased, and the film may be torn or sufficient molding may not be performed during molding processing.

In one embodiment, the polyester composition of the support layer A may comprise homopolyester as a main component and include a copolymer polyester and inorganic particles, wherein the content of copolymer polyester is preferably 30.0% by weight and the content of inorganic particles is more than 0.01% by weight and less than 20% by weight, based on 100% by weight of the total composition.

When the content of the copolymer polyester in the polyester composition of the support layer A is 30% by weight or more, the heat resistance of the support layer is deteriorated and thus a problem arises in that various surface defects, such as, peeling-off, dents, scratches, and the like, are generated on the film surface due to adhesion to a mold during the press processing or vacuum compression molding.

In addition, when the content of inorganic particles in the polyester composition of the support layer A is 0.01% by weight or less, there is a problem in that a large amount of scratches are caused on the film surface due to insufficient running properties during the film-forming process, and when the content of the inorganic particles is 20% by weight or more, a problem of film tearing or the like may easily occur during the stretching process of the film-forming process.

In one embodiment, the storage elastic modulus E′ of the reflective film at 200° C. is preferably 40 MPa to 100 MPa. The biaxially oriented polyester reflective film prepared in the present invention, when subjected to press molding or vacuum compression molding at a high temperature of 190° C. or higher during molding processing, deforms due to the high-temperature heat and pressure. When the storage elastic modulus E′ of the reflective film at 200° C. is less than 40 MPa, the molding processability is excellent, but the pores 24 in the polyester reflective film are easily deformed, and thus the reflection performance is deteriorated. When the storage elastic modulus E′ of the reflective film exceeds 100 MPa, the change of pores in the film is minimized during molding processing, but the molding processability is deteriorated.

In one embodiment, the total thickness of the biaxially oriented polyester reflective film is preferably 150 μm to 400 μm. This is because, if the total thickness of the reflective film is less than 150 μm, there is a problem in that molding workability is remarkably decreased or the film is torn during molding process because the thickness is too thin. If the total thickness of the reflective film exceeds 400 μm, stable production is difficult, for example, breakage occurs during the polyester reflective film forming process, manufacturing cost is increased due to the thick thickness, and the total thickness of a manufactured liquid crystal display is increased, which makes it challenging to achieve a slim design.

In one embodiment, the thickness of the support layer A is preferably more than 1.0% and less than 10.0% of the thickness of the light reflection layer B. That is, the thickness ratio between the support layer A and the light reflection layer B (thickness of support layer A/thickness of light reflection layer B)*100% is preferably more than 1.0% and less than 10.0%. This is because, if the thickness ratio of the support layer A to the thickness of the light reflection layer B is 1.0% or less, the processing defects, such as film tearing or the like, are likely to occur during film stretching process since the support layer A cannot serve as a sufficient support during the film-forming process. If the thickness ratio is 10.0% or more, sufficiently moldability is not obtained during reflective film molding process at high temperature since the support layer A in which the pores 24 are not formed is too thick.

In one embodiment, the specific gravity of the biaxially oriented polyester reflective film is preferably 0.7 to 1.2 g/cm³. This is because, if the specific gravity of the reflective film is less than 0.7 g/cm³, stable production is difficult, for example, breakage occurs during the polyester reflective film forming process, and dimensional stability is significantly decreased due to heat treatment during molding processing. If the specific gravity of the reflective film exceeds 1.2 g/cm³, manufacturing cost is increased, and the reflection characteristics are remarkably deteriorated since the pores are not sufficiently formed in the light reflection layer of the polyester reflective film.

Then, a method of producing a biaxially oriented polyester reflective film according to another aspect of the present invention will be described. Descriptions redundant to the above-described biaxially oriented polyester reflective film according to one aspect of the present invention will be omitted.

The method of producing a biaxially oriented polyester reflective film according to another aspect of the present invention includes a first step of drying each of a polyester composition of a support layer A and a polyester composition of a light reflection layer B, a second step of preparing an non-stretched sheet by melt-extruding the compositions of the first step, a third step of preparing a uniaxially stretched reflective film by uniaxially stretching the non-stretched sheet in a longitudinal direction, a fourth step of preparing a biaxially stretched reflective film by stretching again the uniaxially stretched reflective film in a transverse direction, a fifth step of performing heat treatment on the biaxially stretched reflective film, a sixth step of cooling and winding the heat-treated reflective film, a seventh step of molding the reflective film produced in the sixth step into a form in which a plurality of recessed light collecting structures are arranged in a lattice shape using a molding mold, and an eighth step of forming (punching) holes for mounting LEDs in the recessed light collecting structures of the reflective film produced in the seventh step.

The first step is to dry each of the polyester composition of the support layer A and the polyester composition of the light reflection layer B at a temperature of 100° C. to 200° C. in each dryer, wherein moisture present in a resin is removed by drying the compositions for 3 to 10 hours, under high vacuum. The reason for removing the moisture through drying process is to overcome a problem which may occur in that, if a polyester resin is hydrolyzed by residual moisture in the resin during melt-extrusion process, sheet molding is poorly performed in T-die extrusion process due to rapid decrease of melt viscosity of the polyester, or bubbles are generated in a discharged polymer and thus film-forming is impossible.

The second step is to obtain an non-stretched sheet by melt-extruding the compositions of the first step, wherein the dried polyester composition of the support layer A and the dried polyester composition of the light reflection layer B are melt-extruded at 250° C. to 300° C. using coextrusion equipment having an extruder A′ and an extruder B′, and then are introduced into a T-die multiple nozzle. In the T-die multiple nozzle, an A/B/A layered structure in which the support layer A is positioned on each surface of the light reflection layer B is formed and a melted resin is cooled and solidified using a T-die and a casting drum to obtain the non-stretched sheet.

The third step is to prepare a uniaxially stretched film by uniaxially stretching the obtained non-stretched sheet in a longitudinal direction, wherein the non-stretched sheet is heated to a temperature greater than or equal to a glass transition temperature of the polyester resin by heating means, such as heating of a roll and heating by an infrared heater, and then is preferably stretched by three to five times using a circumferential speed difference of two or more rolls.

The fourth step is to produce a biaxially stretched film by stretching the film uniaxially stretched in the longitudinal direction again in the transverse direction, wherein oven equipment called a tenter that stretches a film in a width direction using traveling clips is used to preheat the film stretched in the longitudinal direction in the third step to a temperature within the glass transition temperature of the polyester resin plus 50° C. in an oven in which a plurality of heating zones and a plurality of stretching zones are formed, and then the film is stretched by three to five times in a transverse direction within the same temperature range.

The fifth step is to perform heat treatment for securing dimensional stability and orientational relaxation of the film stretched in the tenter equipment, wherein heat treatment is performed at a temperature below or equal to the melting point of the polyester plus 30° C. within a plurality of heat treatment regions formed in the same tenter equipment. In this case, in order to secure high dimensional stability and molding properties in the heat treatment process, orientational relaxation and uniform orientation in a transverse direction of the biaxially stretched film are required, which may be carried out by the following method.

When the film biaxially stretched in a longitudinal direction and a transverse direction is subjected to heat treatment in the tenter, relaxation of transversely oriented chains occurs, wherein a central portion in a width direction is sufficiently relaxed in a transverse direction whereas portions adjacent to the clips cannot be sufficiently relaxed in a transverse direction due to the clips, so that a bowing phenomenon takes place in which excessive orientation in the shape of a bow occurs in the tenter. To overcome such a phenomenon, it is preferable to keep a temperature difference between a transversely stretched end region of the fourth step where the bowing phenomenon severely occurs and a heat treatment start region of the fifth step within 30° C.

In addition, for orientational relaxation, it is preferable to provide a plurality of heat treatment regions and to proceed with the heat treatment by gradually increasing a temperature from a start region to an end region, a temperature difference between the heat treatment start region and the heat treatment end region is preferably 30° C. to 100° C., and a temperature of the heat treatment end region is preferably greater than or equal to the melting point of the polyester. Also, when additional stretching by 0.05 times to 0.5 times in a transverse direction is performed in the heat treatment region, the bowing phenomenon is alleviated, so that uniform orientation in a width direction can be achieved.

The sixth step is to steadily cool down and wind the biaxially stretched film by utilizing the plurality of heat treatment regions within the above tenter equipment, and a biaxially oriented polyester reflective film may be obtained through this step of winding the cooled film.

The seventh step is to mold the reflective film prepared in the sixth step in a form in which a plurality of recessed light collecting structures are arranged in a lattice shape using a molding mold 200 in which a plurality of light collecting structures each having a recess portion 12 at the center thereof are arranged. Through the light collecting structures, light reflected by the reflective film is not scattered in all directions but reflected in a centrally concentrated form, thereby enabling local dimming for individual LEDs. In this case, the prepared biaxially oriented polyester reflective film preferably satisfies conditions for an internal angle (wall angle) of the reflective film and an internal angle (wall angle) of the molding mold shown in FIG. 4. The conditions for the internal angles will be described in detail with reference to Equation 1 which will be described below.

The eighth step is to form (punch) a hole 13 for mounting an LED within the recessed light collecting structure of the reflective film prepared in the seventh step, and the shape of the hole 13 may be a variety of shapes, such as a circle, an ellipse, a rectangle, or the like, depending on the shape of the LED, and is preferably a circle.

The biaxially oriented polyester reflective film according to one embodiment, which is prepared through the above-described method, preferably has technical features shown below.

First, in the biaxially oriented polyester reflective film according to one embodiment, the physical properties change (before hole processing) of the center portion of the recess portion 12 recessed at the center thereof before and after molding using the molding mold preferably satisfies conditions (4) to (7) below.
(4) Optical density (OD) before molding >1.4
(5) Decrease in OD before and after molding <0.15
(6) Deviation in OD after molding <7%
(7) Decrease in thickness (d) before and after molding <30%

That is, the OD of the biaxially oriented polyester reflective film before molding preferably satisfies a condition exceeding 1.4. When the OD is 1.4 or less, a transmittance is increased, so that sufficient reflection performance is not realized, thereby reducing the luminance (brightness) of a manufactured liquid crystal display. In addition, when comparing OD before and after the molding process of the seventh step in the process of producing the reflective film, it is preferable that a decrease in OD before and after molding of the reflective film satisfies less than 0.15. This is because, even when the decrease in OD before and after molding is 0.15 or more, the molded reflective film does not provide sufficient reflection performance, and thus has the same drawback in that luminance (brightness) of the manufactured liquid crystal display is reduced. Moreover, if the deviation in OD measured at the center portion of each recess portion before hole processing is performed on the recess portion recessed at the center thereof after molding is 7% or more, it can be seen that molding has not been performed uniformly over the entire surface of the reflective film, and there is a problem in that luminance mura (brightness difference) of the manufactured liquid crystal display occurs. In addition, when the decrease of the thickness d before and after molding is 30% or more, the shape of the pores in the light reflection layer is deformed, so that the molded reflective film does not provide sufficient reflection performance and the rigidity of the film is deteriorated.

Then, the biaxially oriented polyester reflective film according to one embodiment preferably satisfies Equation 1 below. Equation 1 is a measure for evaluating moldability of the reflective film.

$$\frac{{WA}_{r} - {WA}_{m}}{{WA}_{r}} \times \leq 100 \% \leq 5 \% \qquad ( Equation 1 )$$

Here, WAₘ denotes a wall angle of a molding mold and WAᵣ denotes a wall angle of a reflective film after molding. That is, WAᵣ denotes an internal angle between an imaginary line, which connects a convex portion 11 that is the uppermost point of the reflective film 10 after molding and a contact point 32 at which the reflective film 10 touches the molding mold 200, and the recess portion 12 of the reflective film 10, and WAₘ denotes internal angle of the molding mold 200.

In the biaxially oriented polyester reflective film according to one embodiment, it is preferably that a relationship between the internal angles of the molding mold 200 and the reflective film 10 according to Equation 1 satisfies 5% or less.

This is because, if a value of Equation 1 exceeds 5%, there is a limit in reducing the size of a plurality of recessed light collecting structures in the molded reflective film, and accordingly there is a limitation in mounting a plurality of LEDs to increase the efficiency of local dimming.

Hereinafter, the structure of the present invention and the effects thus obtained will be described in detail with reference to Examples and Comparative Examples. However, the Examples are provided to describe the present invention in more detail, and the scope of the present invention is not limited to the Examples.

### EXAMPLES

### Example 1

A support layer A was formed on both sides of a light reflection layer B to form a reflective film in which layers were laminated in the order of support layer A/light reflection layer B/support layer A and a thickness ratio of the support layer A to the light reflection layer B was 5% based on the total thickness of 250 μm. Raw materials were designed such that the support layer A had a composition of 89.9% by weight of polyethylene terephthalate (Toray Advanced Materials Korea Inc., A9093) as homopolyester, 10% by weight of copolymer polyester (Eastman Chemical Company, GN071), and 0.1% by weight of silica with an average particle diameter of 2.0 μm as inorganic particles and the support layer B had a composition of 63% by weight of polyethylene terephthalate (Toray Advanced Materials Korea Inc., A9093) as homopolyester, 15% by weight of copolymer polyester (Eastman Chemical Company, GN071), 8% by weight of copolymerized resin of ethylene and norbornene, which is a non-crystalline cyclic olefin copolymer (Polyplastics Co., Ltd., Topas6017, Tg 170° C.), as resin incompatible with polyester, and 14% by weight of calcium carbonate particles with an average particle diameter of 0.6 μm as inorganic particles, and thereafter, the support layer A of extruder A′ and the light reflection layer B of extruder B′ were co-extruded into A/B/A layers at 280 degrees, and were cooled and solidified using a T-die and a casting drum to obtain a non-stretched sheet.

Thereafter, a reflective film was prepared with the above-described producing method by biaxially stretching the non-stretched sheet by 3.2 times in a longitudinal direction and by 3.6 times in a transverse direction. Then, a biaxially oriented polyester reflective film was prepared in the form shown in FIG. 1 using a prepared molding mold of 200 mm in width and 300 mm in length. At this time, after pretreatment was performed at a film heating temperature of 200° C. for a heating time of 10 seconds using a small vacuum compression molding machine (FKS-0632-20) of Asano Laboratories Co. Ltd., the biaxially oriented polyester reflective film, which was a molded article in the same shape as the molding mold, was prepared through vacuum compression molding.

### Example 2 to Example 6

The biaxially oriented polyester reflective film was prepared in the same method as in Example 1, except that the contents of constituent materials in the light reflection layer B were changed as shown in Table 1 below and was each taken as each of Example 2 to Example 6.

### Comparative Examples

### Comparative Example 1 to Comparative Example 6

Except that the contents of constituent materials of the light reflection layer B were changed as shown in Table 1 below, a biaxially oriented polyester reflective film was prepared in the same method as in Example 1 and was each taken as each of Comparative Example 1 to Comparative Example 6.

### Comparative Example 7

A biaxially oriented polyester reflective film was prepared in the same method as in Example 1, except the change to a non-crystalline cyclic olefin copolymer (Polyplastics Co., Ltd., Topas6015, Tg 150° C.) having 150° C. of Tg of resin incompatible with polyester in the light reflection layer B in Example 1.

### Comparative Example 8

A biaxially oriented polyester reflective film was prepared in the same method as in Example 1, except that the thickness ratio of the support layer A to the light reflection layer B was changed to 0.7%.

### Comparative Example 9

A biaxially oriented polyester reflective film was prepared in the same method as in Example 1, except that the thickness ratio of the support layer A to the light reflection layer B was changed to 13%.

The constituent materials and their contents of the biaxially oriented polyester reflective films according to the above-described Examples 1 to 6 and Comparative Examples 1 to 9 are shown in Table 1 below.

TABLE 1

| | | | | | | | | Resin | | | |
|---|---|---|---|---|---|---|---|---|---|---|---|
| | | | | | | Copolymer | | incompatible with | | | |
| | Volume condition of light | | | Homopolyester | | polyester | | polyester | | Inorganic particles | |
| | reflection layer composition | | | (Specific | | (Specific | | (Specific | | (Specific | |
| | (Volume %) | | | gravity: 1.4) | | gravity: 1.4) | | gravity: 1.02) | | gravity: 2.71) | |
| | | | (Vo + Vi)/ | weight | volume | weight | volume | weight | volume | weight | volume |
| | Vo + Vi | Vo/Vi | Vc | % | % | % | % | % | % | % | % |
| Example 1 | 13.0 | 1.52 | 1.14 | 63 | 45.00 | 15 | 11.36 | 8 | 7.84 | 14 | 5.17 |
| Example 2 | 14.1 | 0.53 | 1.24 | 55 | 39.29 | 15 | 11.36 | 5 | 4.90 | 25 | 9.23 |
| Example 3 | 19.0 | 1.06 | 1.26 | 45 | 32.14 | 20 | 15.15 | 10 | 9.80 | 25 | 9.23 |
| Example 4 | 8.3 | 0.89 | 0.73 | 69 | 49.29 | 15 | 11.36 | 4 | 3.92 | 12 | 4.43 |
| Example 5 | 13.4 | 1.42 | 2.94 | 71 | 50.71 | 6 | 4.55 | 8 | 7.84 | 15 | 5.54 |
| Example 6 | 13.4 | 1.42 | 0.63 | 49 | 35.00 | 28 | 21.21 | 8 | 7.84 | 15 | 5.54 |
| Comparative | 14.2 | 2.21 | 1.25 | 63 | 45.00 | 15 | 11.36 | 10 | 9.80 | 12 | 4.43 |
| Example 1 | | | | | | | | | | | |
| Comparative | 13.1 | 0.43 | 1.16 | 56 | 40.00 | 15 | 11.36 | 4 | 3.92 | 25 | 9.23 |
| Example 2 | | | | | | | | | | | |
| Comparative | 21.0 | 1.28 | 1.39 | 43 | 30.71 | 20 | 15.15 | 12 | 11.76 | 25 | 9.23 |
| Example 3 | | | | | | | | | | | |
| Comparative | 7.6 | 1.06 | 0.67 | 71 | 50.71 | 15 | 11.36 | 4 | 3.92 | 10 | 3.69 |
| Example 4 | | | | | | | | | | | |
| Comparative | 13.4 | 1.42 | 3.53 | 72 | 51.43 | 5 | 3.79 | 8 | 7.84 | 15 | 5.54 |
| Example 5 | | | | | | | | | | | |
| Comparative | 13.4 | 1.42 | 0.48 | 40 | 28.57 | 37 | 28.03 | 8 | 7.84 | 15 | 5.54 |
| Example 6 | | | | | | | | | | | |
| Comparative | 13.0 | 1.52 | 1.14 | 63 | 45.00 | 15 | 11.36 | 8 | 7.84 | 14 | 5.17 |
| Example 7 | | | | | | | | | | | |
| Comparative | 13.0 | 1.52 | 1.14 | 63 | 45.00 | 15 | 11.36 | 8 | 7.84 | 14 | 5.17 |
| Example 8 | | | | | | | | | | | |
| Comparative | 13.0 | 1.52 | 1.14 | 63 | 45.00 | 15 | 11.36 | 8 | 7.84 | 14 | 5.17 |
| Example 9 | | | | | | | | | | | |

Physical properties were measured through the following Experimental Example using the biaxially oriented polyester reflective films according to the above Examples 1 to 6 and Comparative Examples 1 to 9, and the measurement results are shown in Table 2 below.

### Experimental Example

### 1. Measurement of Thickness

A thickness of a prepared biaxially oriented polyester reflective film was measured according to JIS C2151-2006 of the Japan Standards Association, which is a test method for plastic films for electrical use. A biaxially oriented polyester reflective film according to the present invention was cut in the thickness direction using a microtome to obtain a section sample. Then, the thicknesses of the support layer A and the light reflection layer B were measured from a cross-sectional photograph of the section sample enlarged 250 times by transmission electron microscope S800 produced by Hitachi, Ltd.

In addition, after molding processing of the prepared biaxially oriented polyester reflective film through the molding mold 200, a section sample was obtained and the thickness of a center portion of each of a plurality of recessed light collecting structures arranged in a lattice shape was measured in the same method as described above.

### 2. Measurement of Storage Elastic Modulus E′

In order to measure storage elastic modulus E′ of the prepared biaxially oriented polyester reflective film, the biaxially oriented polyester reflective film according to the present invention was cut to a size of 16 mm in width and 5 mm in length to obtain a section sample. Subsequently, storage elastic modulus E′ of the reflective film was measured using a dynamic viscoelasticity measuring device (DMA, TI Instruments, Q800) under conditions of temperature range of 30° C. to 220° C., heating rate of 3° C./minute, strain of 1.0%, and static force of 0.05N.

### 3. Optical Density (OD) Measurement

OD of the prepared biaxially oriented polyester reflective film was measured using a densitometer (Gretag D200-II) produced by GertagMacbeth. Each of the center portions of the plurality of recessed light collecting structures arranged in a lattice shape was measured before molding using a molding mold and after molding process through the molding mold 200.

### 4. Measurement of Specific Gravity

The prepared biaxially oriented polyester reflective film was cut to a size of 10 cm×10 cm, and then a weight of a sample was precisely weighed by an electronic balance (AC100 produced by Mettle) having an accuracy of 0.1 mg. Thereafter, an average value was obtained by measuring the 10-point thicknesses of the weighed sample with a static pressure thickness gauge, and a specific gravity was calculated by the following Equation.

Specific gravity=Weight(g) of film/Thickness(um) of film*100

### 5. Measurement of Internal Angle

The shape and dimension of the prepared biaxially oriented polyester reflective film were measured using three-dimensional surface shape measuring instrument (VR-3200) produced by Keyence.

### 6. Test for Stability of Film Forming

Stability of film forming was evaluated according to the following criteria.

∘: Film forming is stably performed for 6 hours or longer without breakage of film

X: Breakage of film occurs within 6 hours

TABLE 2

| | | | | | Thickness | | | | | |
|---|---|---|---|---|---|---|---|---|---|---|
| | | | | | reduction | | | | | Stability |
| | Thickness | | E′ at | | after | OD before | OD after molding | | | of |
| | ratio (%) of | Equation | 200° C. | Specific | molding | molding | | | Deviation | film- |
| | support layer | 1 (%) | (Mpa) | gravity | (%) | Average | Average | Decrease | (%) | forming |
| Example 1 | 5% | 2 | 54 | 0.80 | 21% | 1.65 | 1.56 | −0.09 | 3.3 | ◯ |
| Example 2 | 5% | 4 | 96 | 0.75 | 16% | 1.71 | 1.65 | −0.06 | 1.2 | ◯ |
| Example 3 | 5% | 3 | 83 | 0.70 | 27% | 1.75 | 1.62 | −0.13 | 3.2 | ◯ |
| Example 4 | 5% | 3 | 77 | 0.95 | 19% | 1.45 | 1.38 | −0.07 | 3.8 | ◯ |
| Example 5 | 5% | 4 | 91 | 0.80 | 13% | 1.69 | 1.64 | −0.05 | 1.2 | ◯ |
| Example 6 | 5% | 2 | 42 | 0.85 | 24% | 1.62 | 1.49 | −0.13 | 4.9 | ◯ |
| Comparative | 5% | 1 | 26 | 0.7 | 36% | 1.68 | 1.5 | −0.18 | 7.6 | ◯ |
| Example 1 | | | | | | | | | | |
| Comparative | 5% | 22 | 107 | 0.8 | 11% | 1.70 | 1.68 | −0.02 | 1.2 | ◯ |
| Example 2 | | | | | | | | | | |
| Comparative | 5% | 3 | 79 | 0.65 | 45% | 1.77 | 1.58 | −0.19 | 1.9 | X |
| Example 3 | | | | | | | | | | |
| Comparative | 5% | 22 | 121 | 1.15 | 7% | 1.38 | 1.28 | −0.04 | 4.7 | ◯ |
| Example 4 | | | | | | | | | | |
| Comparative | 5% | 17 | 103 | 0.8 | 17% | 1.68 | 1.60 | −0.08 | 1.3 | X |
| Example 5 | | | | | | | | | | |
| Comparative | 5% | 1 | 36 | 0.85 | 53% | 1.57 | 1.33 | −0.24 | 8.4 | ◯ |
| Example 6 | | | | | | | | | | |
| Comparative | 5% | 1 | 34 | 0.80 | 38% | 1.65 | 1.39 | −0.26 | 8.1 | ◯ |
| Example 7 | | | | | | | | | | |
| Comparative | 0.7% | 1 | 42 | 0.78 | 28% | 1.67 | 1.57 | −0.05 | 3.9 | X |
| Example 8 | | | | | | | | | | |
| Comparative | 13% | 12 | 86 | 0.82 | 14% | 1.61 | 1.56 | −0.05 | 2.4 | ◯ |
| Example 9 | | | | | | | | | | |

As can be seen from Table 2, it is confirmed that the biaxially oriented polyester reflective films according to Examples 1 to 6 of the present invention have excellent moldability, light reflection characteristics, and stability of film forming, and low molding variation.

On the contrary, Comparative Example 1 has a value of 2.21 at condition (2) and thus does not satisfy condition (2) where a value regarding volume % of components of the light reflection layer composition should be 1.6 or less. That is, the volume % of inorganic particles contained is small compared to that of the resin incompatible with polyester, and hence the storage elastic modulus E′ of the reflective film at 200° C. is lowered, which may cause the film to deform easily during molding at high temperature. Accordingly, the film may be torn during a molding process, or the thickness thereof is significantly reduced and OD decreases after molding so that sufficient reflection performance cannot be implemented, thereby reducing the luminance of a produced display. In addition, there is a problem in that deviation in OD after molding increases because uniform molding is not achieved in the molding process.

Also, Comparative Example 2 has a value of 0.43 at condition (2) and thus does not satisfy condition (2) where a value regarding volume % of components of the light reflection layer composition should be 0.5 or more. That is, the volume % of inorganic particles contained is large compared to the resin incompatible with polyester, and hence the storage elastic modulus E′ of the reflective film at 200° C. is increased, and accordingly the film is difficult to deform in the process of hot-temperature molding to a lattice shape of recessed reflection structures with a molding mold. Also, a value calculated by Equation 1 is 22%, which does not satisfy the condition that requires the value to be 5% or less, and thus moldability is significantly lowered, which makes it difficult to form a desired molded article, thereby imposing a limitation in mounting a plurality of LEDs for improving the efficiency of local dimming.

In addition, Comparative Example 3 has a value of 21% by volume at condition (1) and thus does not satisfy condition (1) where a value regarding volume % of components of the light reflection layer composition should be 20% by volume or less. That is, the resin incompatible with polyester and the inorganic particles are contained in a large volume %, and hence the density of pores in the light reflection layer is increased during film forming, which causes a rapid reduction of stretchability and a high possibility of processing defects, such as tearing of light reflection film. Also, due to the low specific gravity, thickness reduction may occur in the molding process, and thus a problem of decrease in OD after molding is likely to occur.

Comparative Example 4 has a value of 7.6% by volume at condition (1) and thus does not satisfy condition (1) where a value regarding volume % of components of the light reflection layer composition should be 8% by volume or more. That is, the resin incompatible with polyester and the inorganic particles are contained in a small volume %, and hence pores are not sufficiently formed during the film-forming process of the reflective film, so that the specific gravity is increased and the storage elastic modulus E′ at 200° C. is increased. Accordingly, the film is difficult to deform in the process of hot-temperature molding to a lattice shape of recessed reflection structures with a molding mold, and moldability calculated by Equation 1 is significantly reduced, which makes it difficult to form a desired molded article.

Also, Comparative Example 5 has a value of 3.53 at condition (3) and thus does not satisfy condition (3) where a value regarding volume % of components of the light reflection layer composition should be 3 or less. That is, volume % of the copolymer polyester resin is lower than volume % of the resin incompatible with polyester and the inorganic particles, and hence crystallization is not sufficiently suppressed in the film-forming process of the reflective film, which causes a rapid reduction of stretchability and a high possibility of processing defects, such as tearing of light reflection film, in the stretching process. Moreover, since the storage elastic modulus E′ is increased, the film is difficult to deform in the process of hot-temperature molding to a lattice shape of recessed reflection structures with a molding mold. Also, a value calculated by Equation 1 is 17%, which does not satisfy the condition that requires the value to be 5% or less, and thus moldability is significantly lowered, which makes it difficult to form a desired molded article.

In addition, Comparative Example 6 has a value of 0.48 at condition (3) and thus does not satisfy condition (3) where a value regarding volume % of components of the light reflection layer composition should be 0.6 or more. That is, volume % of the copolymer polyester resin is higher than volume % of the resin incompatible with polyester and the inorganic particles, and hence crystallization is sufficiently suppressed, but the storage elastic modulus E′ of the reflective film at 200° C. is lowered, so that the film is easy to deform during molding at high temperature. Accordingly, the film may be torn during a molding process, or the thickness thereof is significantly reduced and OD decreases after molding so that sufficient reflection performance cannot be implemented, thereby reducing the luminance of a produced display. In addition, there is a problem in that deviation in OD after molding increases because uniform molding is not achieved in the molding process.

Comparative Example 7 uses the non-crystalline cyclic olefin copolymer having 150° C. of glass transition temperature (Tg) of the resin incompatible with polyester in the light reflection layer composition, which does not satisfy the condition where Tg is 160° C. or higher. The resin incompatible with polyester particles formed in the pores in the light reflection layer are easy to deform in the molding processing process at high temperature, so that the thickness is significantly reduced and OD decreases after molding, and hence sufficient reflection performance cannot be implemented, thereby reducing the luminance of a produced display. In addition, there is a problem in that deviation in OD after molding increases because uniform molding is not achieved in the molding process.

In Comparative Example 8, a thickness ratio of the support layer A to the light reflection layer B is 0.7%, which does not satisfy a condition where the thickness ratio of the support layer A to the light reflection layer B exceeds 1%. Accordingly, in the process of film forming of the reflective film, the film is not sufficiently supported during stretching and thus stretchability is rapidly reduced and processing defects, such as tearing of light reflection film, occurs.

In Comparative Example 9, a thickness ratio of the support layer A to the light reflection layer B is 13%, which does not satisfy a condition where the thickness of the support layer A to the light reflection layer B is less than 10% and a value calculated by Equation 1 is 12%, which does not satisfy a condition that requires the value to be 5% or less. Accordingly, moldability is greatly reduced, thereby making it difficult to form a desired molded article.

As described above, according to the biaxially oriented polyester reflective film in accordance with one embodiment of the present invention and a method of producing the same, it is possible to obtain a biaxially oriented polyester reflective film which is not significantly reduced in thickness and retains excellent reflection characteristics even after molding, through design of multilayer of a reflective film, modification of raw materials, adjustment of thermal properties of resin incompatible with polyester and volume ratio of inorganic particles, orientational relaxation producing method, and the like. Therefore, the reflective film may be used for various applications, and in particular, it is confirmed that the reflective film can be suitably used as reflective film for local dimming.

While preferred embodiments of the present invention have been described above in detail, it should be understood that the present invention is not restricted or limited to the illustrated embodiments, and may be modified and improved in various forms by those skilled in the art within the concept of the present invention specified in the appended claims.

1. A biaxially oriented polyester reflective film comprising:
a light reflection layer having pores inside thereof; and
a support layer formed on at least one surface of the light reflection layer,
wherein the light reflection layer comprises a polyester composition including homopolyester, copolymer polyester, resin incompatible with polyester, and inorganic particles,
the support layer comprises a polyester composition including homopolyester, copolymer polyester, and inorganic particles, and
a plurality of light collecting structures recessed at center thereof are arranged in a lattice shape and a hole is formed in a recess portion.

2. The biaxially oriented polyester reflective film of claim 1, wherein the polyester composition of the light reflection layer satisfies the following conditions (1) to (3):
(1) 8% by volume≤Vo+Vi≤20% by volume
(2) 0.5≤Vo/Vi≤1.6
(3) 0.6≤(Vo+Vi)/Vc≤3,
wherein Vo denotes volume % of the resin incompatible with polyester, Vi denotes volume % of the inorganic particles, and Vc denotes the volume % of copolymer polyester when the weight of each component based on total 100% by weight of the polyester composition is divided by specific gravity.

3. The biaxially oriented polyester reflective film of claim 1, wherein storage elastic modulus E′ of the biaxially oriented polyester reflective film at 200° C. is 40 MPa to 100 MPa.

4. The biaxially oriented polyester reflective film of claim 1, wherein the copolymer polyester is a polymer obtained by a polycondensation reaction of 100 mol % of aromatic dicarboxylic acid as an acid component, 60 to 90 mol % of ethylene glycol as total diol components, and 10 to 40 mol % of one or more diol components selected from a group consisting of trimethylene glycol, tetramethylene glycol, 2,2 dimethyl (1, 3-propane) diol, and 1,4-cyclohexanedimethanol.

5. The biaxially oriented polyester reflective film of claim 1, wherein the resin incompatible with polyester is at least one selected from crystalline polyolefin resins, non-crystalline cyclic olefin resins, thermosetting polystyrene resins, thermosetting polyacrylate resins, polypetylenesulfide resins, and fluorine-based resins, or a homopolymer or copolymer thereof.

6. The biaxially oriented polyester reflective film of claim 5, wherein glass transition temperature of the resin incompatible with polyester is 160° C. or higher.

7. The biaxially oriented polyester reflective film of claim 1, wherein the inorganic particles include at least one inorganic particle selected from the group consisting of silica, alumina, barium sulfate, titanium dioxide, and calcium carbonate.

8. The biaxially oriented polyester reflective film of claim 1, wherein an average particle diameter of the inorganic particles of the light reflection layer is more than 0.2 μm and less than 1.2 μm.

9. The biaxially oriented polyester reflective film of claim 1, wherein an average particle diameter of the inorganic particles of the support layer is more than 0.1 μm and less than 10.0 μm.

10. The biaxially oriented polyester reflective film of claim 1, wherein a total thickness of the biaxially oriented polyester reflective film is 150 μm to 400 μm.

11. The biaxially oriented polyester reflective film of claim 1, wherein a thickness of the support layer is more than 1.0% and less than 10.0% of a thickness of the light reflection layer.

12. The biaxially oriented polyester reflective film of claim 1, wherein specific gravity of the biaxially oriented polyester reflective film is 0.7 to 1.2 g/cm³.

13. The biaxially oriented polyester reflective film of claim 1, wherein a physical properties change of a center portion of the recess portion recessed at the center thereof in the biaxially oriented polyester reflective film before and after molding using a molding mold satisfies conditions (4) to (7) below:
(4) Optical density (OD) before molding >1.4
(5) Decrease in OD before and after molding <0.15
(6) Deviation of OD after molding <7%
(7) Decrease in thickness (d) before and after molding <30%.

14. The biaxially oriented polyester reflective film of claim 1, wherein the biaxially oriented polyester reflective film after molding using a molding mold satisfies Equation 1 below
$$\frac{{WA}_{r} - {WA}_{m}}{{WA}_{r}} \times \leq 100 \% \leq 5 \% \qquad ( Equation 1 )$$
wherein WAₘ denotes a wall angle of the molding mold and WAᵣ denotes a wall angle of the reflective film after molding.

15. A method of producing a biaxially oriented polyester reflective film, the method comprising:
a first step of drying each of a polyester composition of a support layer A and a polyester composition of a light reflection layer B;
a second step of preparing an non-stretched sheet by melt-extruding the compositions of the first step;
a third step of preparing a uniaxially stretched reflective film by uniaxially stretching the non-stretched sheet in a longitudinal direction;
a fourth step of preparing a biaxially stretched reflective film by stretching again the uniaxially stretched reflective film in a transverse direction;
a fifth step of performing heat treatment on the biaxially stretched reflective film;
a sixth step of cooling and winding the heat-treated reflective film;
a seventh step of molding the reflective film produced in the sixth step into a form in which a plurality of recessed light collecting structures are arranged in a lattice shape using a molding mold; and
an eighth step of forming (punching) holes for mounting LEDs in the recessed light collecting structures of the reflective film produced in the seventh step.

16. The method of claim 15, wherein the polyester composition of the light reflection layer satisfies the following conditions (1) to (3):
(1) 8% by volume≤Vo+Vi≤20% by volume
(2) 0.5≤Vo/Vi≤1.6
(3) 0.6≤(Vo+Vi)/Vc≤3
wherein Vo denotes volume % of the resin incompatible with polyester, Vi denotes volume % of the inorganic particles, and Vc denotes the volume % of copolymer polyester when the weight of each component based on total 100% by weight of the polyester composition is divided by specific gravity.

17. The method of claim 15, wherein a physical properties change of a center portion of the recess portion recessed at the center thereof in the biaxially oriented polyester reflective film before and after the molding using a molding mold in the seventh step satisfies conditions (4) to (7) below:
(4) Optical density (OD) before molding >1.4
(5) Decrease in OD before and after molding <0.15
(6) Deviation of OD after molding <7%
(7) Decrease in thickness (d) before and after molding <30%.

18. The method of claim 15, wherein the biaxially oriented polyester reflective film after the molding using a molding mold in the seventh step satisfies Equation 1 below
$$\frac{{WA}_{r} - {WA}_{m}}{{WA}_{r}} \times \leq 100 \% \leq 5 \% , \qquad ( Equation 1 )$$
wherein WAₘ denotes a wall angle of the molding mold and WAᵣ denotes a wall angle of the reflective film after molding.
